(19) United States
(12) Patent Application Publication
(10) Pub. No.: US 2016/0313806 A1
(43) Pub. Date: Oct. 27, 2016

(54) APPARATUS AND METHOD FOR USER INPUT

(71) Applicant: NOKIA TECHNOLOGIES OY, Espoo (FI)

(72) Inventors: Runfeng Zhao, Beijing (CN); Xu Jing, Beijing (CN)

(21) Appl. No.: 15/101,529

(22) PCT Filed: Dec. 6, 2013
(86) PCT No.: PCT/CN2013/088801

§ 371 Date: Jun. 3, 2016

(51) Int. Cl. G06F 3/0346; G06F 3/01

(52) U.S. Cl. CPC G06F 3/0346; G06F 3/014

(57) ABSTRACT

An apparatus comprising: a support configured to position the apparatus adjacent a wrist of a hand of a user; first sensors configured to measure movement of the apparatus in space as the hand is moved through space; and one or more second sensors configured to measure at least a local force applied to the apparatus at the wrist as a consequence of movement, by the user, of a phalange of the hand.

### TECHNOLOGICAL FIELD

Embodiments of the present invention relate to an apparatus and/or method for user input. In particular, they relate to an apparatus and/or method for single-handed user input.

### BACKGROUND

Some user inputs, such as keyboards, enable the efficient input of text. Other user inputs, such as a computer mouse, a roller-ball or a touch pad, enable user input, for example, to a graphical user interface (GUI). Typically, in a GUI, a position of a pointer within a display is controlled using a user input device. The user input device enables a user to input user commands to the GUI associated with a position of the pointer within the display.

### BRIEF SUMMARY

According to various, but not necessarily all, embodiments of the invention there is provided an apparatus comprising: a support configured to position the apparatus adjacent a wrist of a hand of a user; first sensors configured to measure movement of the apparatus in space as the hand is moved through space; and one or more second sensors configured to measure at least a local force applied to the apparatus at the wrist as a consequence of movement, by the user, of a phalange of the hand.

According to various, but not necessarily all, embodiments of the invention there is provided a system comprising the apparatus described above and further comprising an electronic device configured to receive user input commands from the apparatus, wherein the electronic device comprises at least an interface for receiving signals from the apparatus, a processor and a memory and wherein the processor and memory are configured to provide in combination an application programming interface that translates positional signals provided by the first sensors and control signals provided by the second sensors to standard computer mouse signals.

According to various, but not necessarily all, embodiments of the invention there is provided a method comprising: processing signals received from first sensors connected to a wrist of a hand of a user to measure movement of the hand of the user through space; and processing signals received from one or more second sensors attached to the wrist of the hand of the user to measure local forces applied at the wrist as a consequence of moving one or more phalanges of the hand to detect a user input signal.

According to various, but not necessarily all, embodiments of the invention there is provided an apparatus comprising: means for positioning the apparatus adjacent a wrist of a hand of a user; first sensing means for sensing movement of the apparatus in space as the hand is moved through space; and second sensing means for sensing at least a local force applied to the apparatus at the wrist as a consequence of movement, by the user, of a phalange of the hand.

### BRIEF DESCRIPTION

For a better understanding of various examples that are useful for understanding the brief description, reference will now be made by way of example only to the accompanying drawings in which:

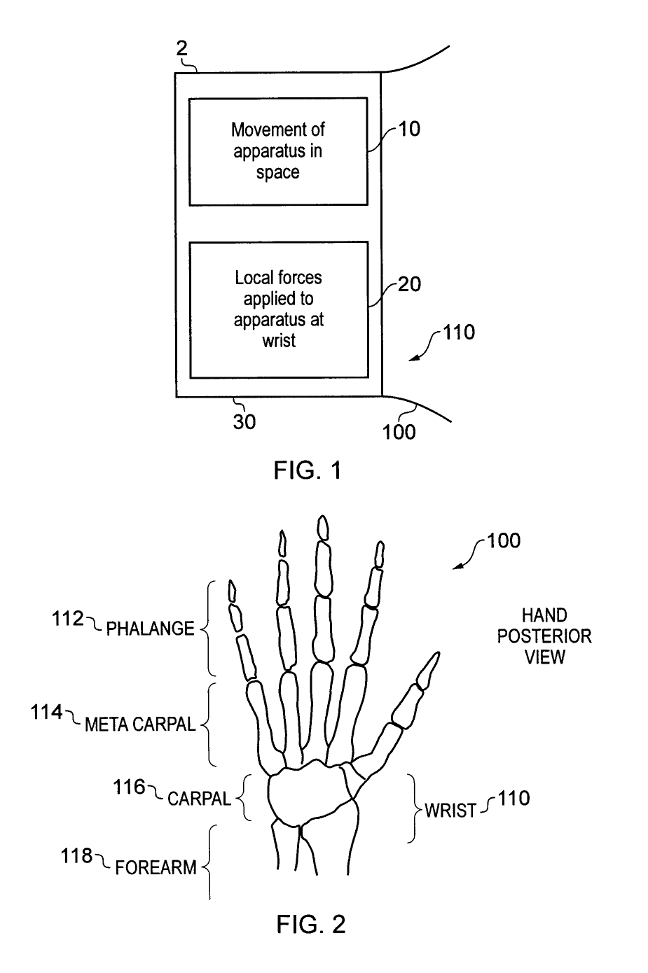

FIG. 1 illustrates an example of an apparatus configured to measure at least a local force applied to the apparatus at a wrist of the user as a consequence of movement, by the user, of a phalange of the user's hand;

FIG. 2 illustrates an example of the skeletal structure of a human hand;

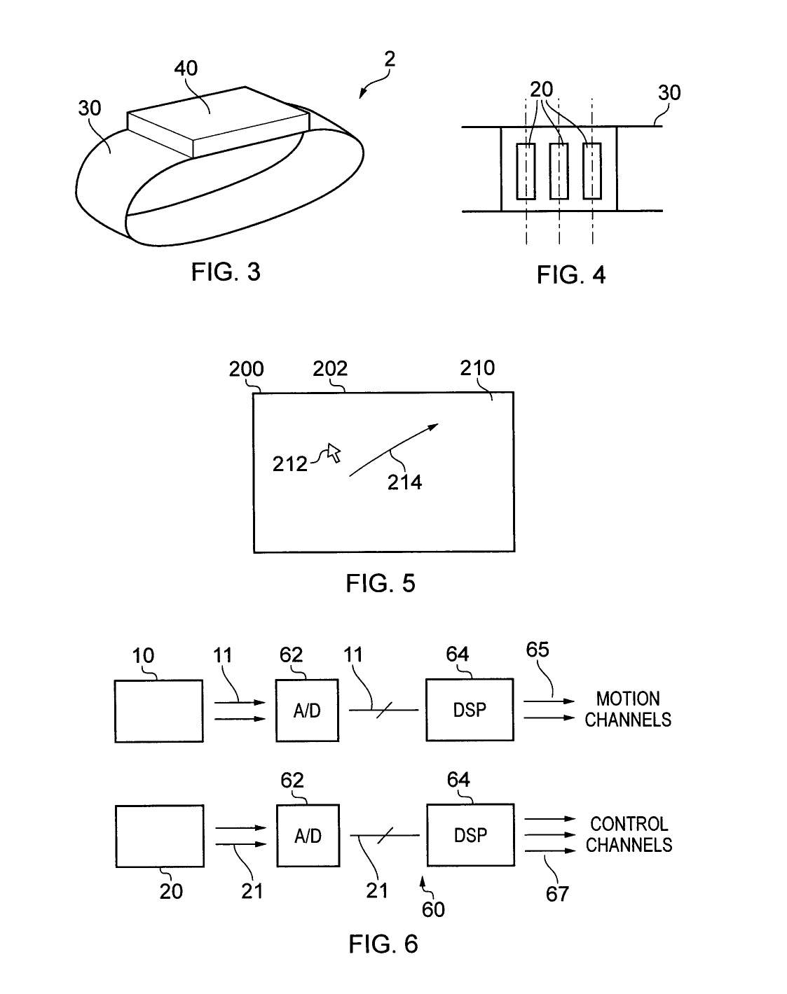

FIG. 3 illustrates an example of the apparatus illustrated in FIG. 1;

FIG. 4 illustrates an example of an underside of the apparatus illustrated in FIG. 3;

FIG. 5 illustrates an example of a controlled apparatus which receives user input commands from an apparatus, for example, as illustrated in FIG. 1, FIG. 3 or FIG. 4;

FIG. 6 illustrates operation of the apparatus to provide control of a pointer within a graphical user interface;

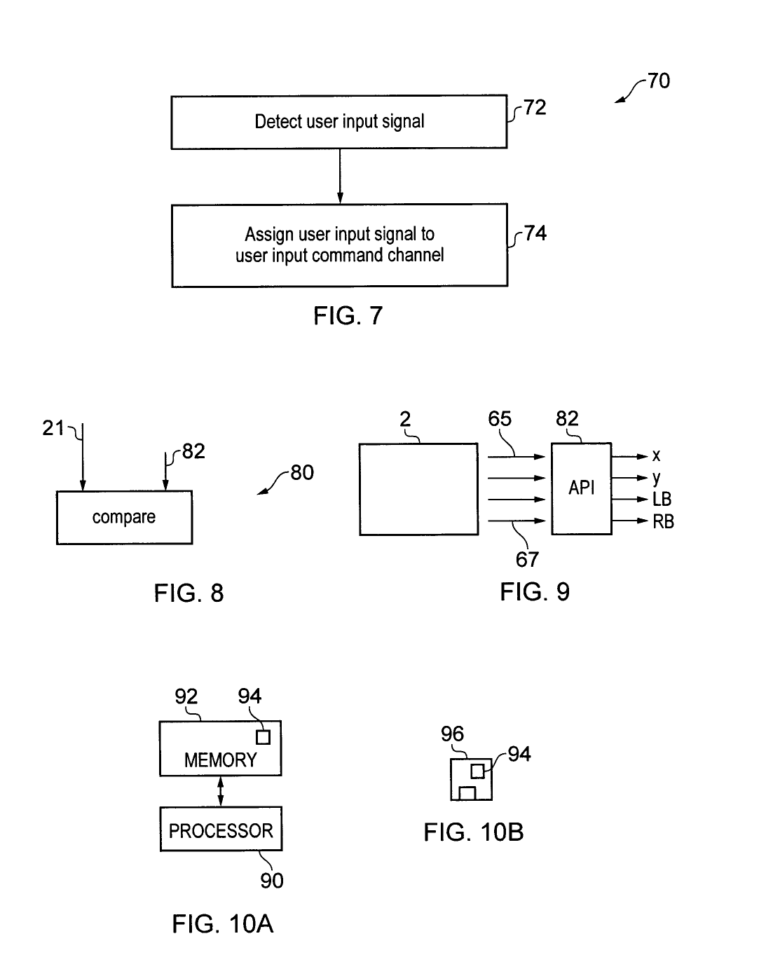

FIG. 7 illustrates an example of a method;

FIG. 8 illustrates an example of a block within the method;

FIG. 9 illustrates use of an application programming interface to produce standard user input commands;

FIG. 10A illustrates an example of circuitry; and

FIG. 10B illustrates an example of a computer program delivery mechanism.

### DETAILED DESCRIPTION

FIG. 1 illustrates an example of an apparatus 2 comprising: a support 30 configured to position the apparatus 2 adjacent a wrist 110 of a hand 100 of a user; first sensors 10 configured to measure movement of the apparatus 2 in space as the hand 100 is moved through space; and one or more second sensors 20 configured to measure at least a local force applied to the apparatus 2 at the wrist 110 as a consequence of movement, by the user, of a phalange (112, FIG. 2) of the hand 100.

The apparatus 2 is configured to operate as a user input device that is configured to provide user input commands to another controlled apparatus.

The first sensors 10 may be configured to measure movement of the apparatus 2 in three-dimensional space as the hand 100 is moved through that three-dimensional space. Suitable sensors include three-axis accelerometers and/or gyroscopes.

FIG. 2 illustrates an example of the skeletal structure of a human hand 100. The view provided is of the posterior of the hand 100. The hand 100 is connected to the forearm 118 via a wrist 110. For the purposes of this description, the wrist 110 will be described as part of the hand 100. Referring to FIG. 2, however, it will be recognised that the area referred to as the wrist 110 includes the carpal region 116 of the hand 100. The forearm 118 is connected via the carpal region 116 to the metacarpals 114. The metacarpals are, in turn, connected to respective phalanges 112.

The metacarpals 114 form the structure of a palm of the hand whereas the phalanges 112 provide the digits including fingers and thumbs.

Long tendons, pulled by forearm muscles, move under the skin at the wrist and cause movement of the phalanges. Tendons on the anterior side of the wrist 101 flex the phalanges 112 when pulled. Tendons on the posterior side of the wrist 119 extend the phalanges 112 when pulled.

The apparatus 2 may be positioned on the wrist 110 such that it overlies at least a portion of the carpal region 116 of the hand 100. When the user flexes a particular phalange 112, the flexor tendon for that phalange 116, on the anterior side of the carpal region 116, moves. When the user extends a particular phalange 112, the extensor tendon for that phalange 116, on the posterior side of the carpal region 116, moves.

The apparatus 2, and in particular the one or more second sensors 20, are configured to detect the movement at the carpal region 116 that occurs as a consequence of movement of, for example, one or more phalanges 112.

The movement of a phalange 112 generates a force which is conveyed to the one or more second sensors 20. This may result in an increased pressure at the one or more second sensors 20 and/or movement or deformation at the one or more second sensors 20. Therefore, the one or more second sensors 20 may be configured to detect the consequences of the force provided, for example, by the tendons when a phalange 112 moves.

In some examples, the second sensors 20 may be pressure sensors, in other examples the second sensors 20 may be deformation sensors that sense a deformation of the apparatus 2.

When a particular phalange 112 is moved a particular portion of the carpal region 116 provides a force to the apparatus 2. It is therefore possible, by arranging one or more second sensors 20 over the wrist 110, to detect separately movement of different phalanges 112 including the fingers and thumb.

It is therefore possible for a user to provide user input commands using the apparatus 2 by moving one or more of his or her phalanges 112 without actually interacting with or touching another object with the phalanges 112.

The purpose of the support 30 is to support the apparatus 2 in a position adjacent a wrist 110 of a hand 100 of a user so that one or more second sensors 20 are positioned to measure at least a local force applied as a consequence of movement, by the user, of a phalange of the hand 100. The support 30 supports the apparatus 2 in this position and resists, prevents or constrains movement of the apparatus 2 away from this position.

FIG. 3 illustrates an example of the apparatus 2. In this example, the support 30 is configured to wrap around a carpal portion 116 of the user's wrist 110.

The support 30 may be configurable to have user adjustable tension so that the one or more second sensors 20 are pressed against the wrist 110. Examples of a support 30 include but are not limited to: a wrist-strap, a wrist-bands, a deformable wrist-sleeve, or some other body or positioner.

FIG. 4 illustrates the underside of the apparatus 2 illustrated in FIG. 3. The figure illustrates the one or more second sensors 20 that are pressed against a posterior portion of the user's wrist 110. In this example there are multiple second sensors 20 each of which is aligned laterally across the wrist 110. Each second sensor 20 is associated with a different portion of the carpal region 116 and therefore primarily detects movement of a particular one of the phalanges 112.

The apparatus 2 illustrated in FIGS. 3 and 4 may provide additional functionality. For example, the apparatus 2 may comprise a display 40 configured to provide visible information to a user. In some examples, the apparatus 2 may be configured to additionally operate as a watch and/or a mobile cellular telephone and/or a controller for an electronic device.

FIG. 5 illustrates an example of a controlled apparatus 200 which receives user input commands from the apparatus 2. The apparatus 200 comprises a display 202 which is used to provide a graphical user interface (GUI) 210. In this example, the graphical user interface 210 comprises a pointer icon 212. This is a widget displayed in the display 202 the location of which can be controlled by the user using the apparatus 2.

For example, the apparatus 2 may be used as a pointing device to control the location of the pointer 212. The movement of the apparatus 2 in space, as measured by the first sensors 10, may result in the movement 214 of the pointer 212 within the display 202.

The movement of a phalange 112 may be detected by the one or more second sensors 10 to provide a control input at the GUI 210. Such a control input may correspond to, for example, a click of a left button (LB), middle button (MB), right button (RB) or wheel of a computer mouse device. It may for example provide for a click operation or in combination with the movement of the apparatus 2 in space a drag operation or a drag and drop operation.

FIG. 6 illustrates the operation of the apparatus 2 to provide control of a pointer within a graphical user interface 210. In this example, the first sensors 10 provide first output signals 11 that are processed to control the position of a pointer 212 within the graphical user interface 210 and the one or more second sensors 20 provide second output signals 21 that are processed to provide control of at least user selection within the graphical user interface 210.

Referring to FIG. 6, the first sensors 10 produce first output signals 11 which are converted by analogue to digital circuitry 62 to digital versions of the first output signals 11. The first input signals 11 are processed in the digital domain by digital processing circuitry 64 to produce first user input signals 65 that provide positional commands that move a pointer 212.

The second sensors 20 provide second output signals 21 to analogue to digital conversion circuitry 62 which produce second output signals 21 in the digital domain. The second output signals 21 are then processed in the digital domain by digital signal processing circuitry 64 to produce second user input signals 67.

As illustrated in block 72 of the method 70 illustrated in FIG. 7, the digital signal processing circuitry 64 is configured to detect a second user input signal 67 within the second output signals 21 provided by the one or more second sensors 20.

As illustrated in FIG. 8, the digital signal processing circuitry 64 may be configured to compare 80 a second output signal 21 received from a second sensor 20 with a reference 82.

The reference 82 may be used to determine when the second output signal 21 varies from a “null” value sufficiently to indicate that a user input at a particular phalange or phalanges 112 has been made.

The comparison 80 may compare the output from a particular one of a second sensor 20 against previous second output signals 21 from that same second sensor 20. In this case the reference 82 is a previous signal from the same sensor. This enables the comparison 80 to take into account how the second output signal 21 from a particular second sensor 20 has varied in time.

The comparison 80 may compare the output from a different one of the second sensors 20 against the output from the particular one of the second sensors 20. In this case the reference 82 is an output signal from a different second sensor 20. The reference 82 may be a contemporaneous output signal from the different second sensor 20 or it may be a previous signal from the different second sensor 20. This enables the comparison 80 to take into account how the second output signal 21 from a particular second sensor varies from the second output signal 21 from a different second sensor either contemporaneously and/or over time.

In some embodiments, it may be desirable to transform the second output signals 21 from the second sensors 20 from the time domain into the frequency domain using, for example, a Fast Fourier Transform. The comparisons of the second output signals 21 against reference signals may then occur in the frequency domain.

After the digital signal processing circuitry 64 has determined that measured second output signals 21 represent a second user input signal 67, it produces an output corresponding to the detected second user input signal 67 as illustrated at block 72 of FIG. 7.

Next, at block 74, the digital signal processing circuitry 64 or other circuitry assigns the user input signal 67 to a particular input command channel. That is, it assigns a meaning to the detected user input signal 67.

While this assignment may occur in the digital signal processing circuitry 64, it may alternatively occur in an application programming interface 82 as illustrated, for example, in FIG. 9. In the example of FIG. 9, the application programming interface 82 receives user input signals 65 and 67 from the apparatus 2, in a standard format, and it converts this standard format of user input signals 67 into a different standard format, for example, the standard format produced by a computer mouse device.

In the example of FIG. 9, the API 82 converts the information provided by the first sensors 10 into an X command that instructs the movement of a pointer 212 in a GUI 210 by a particular amount in the X direction and a Y command that instructs movement of the pointer 212 in the GUI 210 by a particular amount in a Y direction, orthogonal to the X direction.

The API 82 in this example converts the output from the second sensors 20 to an LB command associated with a left button mouse click and/or a RB command associated with a right button mouse click.

It will be appreciated that the output signals of the API 82 are in conformance with the PS/2 communication standard. However, it should be appreciated that the API 82 may be used to convert the user input signals 67 into any required format.

Although in FIG. 9 only the commands LB and RB are illustrated, it is also possible to have additional commands such as the MB command associated with a middle button mouse click and also commands associated with a mouse wheel.

In order to detect second output signals 21 as user input signals 67, it may be necessary to calibrate the apparatus 2. If calibration is required, the circuitry 64 used for detection of user input signals from second output signals 21 may also be used to calibrate the detection of second user input signals 67 from second output signals 21.

For example, the user may perform a pre-defined phalange movement and the output of the second sensors 20 may be compared between themselves and over time to identify the “signature” of that particular movement. The signature can then be parameterised and used as the reference 82 used in block 80 of FIG. 8 to detect user input signals 67 from or within second output signals 21.

The circuitry 64 used for the calibration process may provide instructions to the user, for example, via the display 40 if present. The instructions may, for example, be used to calibrate the first sensors 10 and the second sensors 20.

The calibration process may also assign second user input signals 67 to particular user input command channels. In some embodiments, the relationship between the second user input signals 67 and the user input command channels may be fixed. For example, the movement of the first index finger may always have a particular meaning. However, even in this circumstance, it may be necessary to determine on which hand the apparatus is worn. This may simply be achieved by asking the user to move the first index finger and then move a different finger. By comparing the timing of the outputs of the second sensors 20, it is possible to determine which of the second sensors 20 is associated with the index finger and which is not.

It may also be desirable to assign flexibly second user input signals 67 to particular user input command channels. In this scenario, the display 40 may indicate a particular input command channel such as, for example, left button mouse click. The user then performs the action that they wish to assign to that user input command channel. The circuitry 43 determines the signature of the second output signals 21 associated with that particular phalange movement and assigns the user input signal 57 for that signature to the left button mouse input control channel.

The calibration circuitry 64 is therefore able to set detection thresholds and signatures for second output signals 21 that enable the circuitry 64 to detect a second user input signal 67 within the second output signals 21.

In addition, the calibration circuitry 64 may also be capable of flexibly assigning particular second user input signals 67 to particular user input command channels.

It will therefore be appreciated that the circuitry 64 may process first output signals 11 received from first sensors 10 connected to a wrist 110 of a hand 100 of a user to measure movement of the hand 100 of the user through space; and processes second output signals 21 received from one or more second sensors 20 attached to the wrist 110 of the hand 100 of the user to measure local forces applied at the wrist 110 as a consequence of moving one or more phalanges 112 of the hand 100, to detect a user input signal 67.

In the preceding paragraphs, reference has been made to circuitry that performs various different functions. For example, in relation to FIG. 6 and block 72 of FIG. 7, digital processing circuitry 64 processes first input signals 11 to produce user input signals 65 that, for example, provide user commands that move a pointer 212. Also the digital processing circuitry 64 is described as processing second output signals 21 to produce user input signals 67 which provide user input commands.

Also, as described in relation to block 74 of FIG. 7, circuitry may be provided that assigns a user input signal 67 to a particular input command channel. That is, it assigns a meaning to the user input signal 67.

In addition, calibration circuitry has been described which may be used to calibrate block 72 of FIG. 7 to enable detection of a user input signal within the second output signals 21.

In addition, calibration circuitry has been described which is used to calibrate block 74 in FIG. 7, to enable assignment to a particular user input signal 67 of a particular user input command channel.

Some or all of the circuitry may be comprised within the apparatus 2. Some of this circuitry may be comprised within a controlled apparatus 200, for example, the circuitry which performs block 74 of FIG. 7 which may be performed as an application programming interface 82, as illustrated in FIG. 9.

In some embodiments, the circuitry may be provided in hardware alone, have certain aspects in software including firmware alone, or can be a combination of hardware and software (including firmware).

For example, the circuitry may be implemented using instructions that enable hardware functionality, for example, by using executable computer program instructions in a general purpose or special-purpose processor that may be stored on a computer-readable storage medium (disc, memory, etc) to be executed by such a processor.

FIG. 10A illustrates an example of circuitry comprising a processor 90 and memory 92. The processor 90 is configured to read from and write to the memory 92. The processor 90 may also comprise an output interface via which data and/or commands are output by the processor 90 and an input interface via which data and/or commands are input to the processor 90.

The memory 92 stores a computer program 94 comprising computer program instructions (computer program code) that controls operation of the circuitry when loaded into the processor 90. The computer program instructions, or the computer program 94, provide the logic and routines that enable the circuitry to perform the methods illustrated in, for example, FIG. 6, block 72 FIG. 7, block 74 FIG. 7, FIG. 8 and FIG. 9. The processor 90 by reading the memory 92 is able to load and execute the computer program 94.

The apparatus 2 may therefore comprise: at least one processor 90; and at least one memory 92 including computer program code 94, the at least one memory 92 and the computer program code 94 configured to, with the at least one processor 90, cause the apparatus at least to perform: processing the signals 11 received from first sensors 10 connected to a wrist 110 of a hand 100 of a user to measure movement of the hand 100 of the user through space; and processing signals 21 received from one or more second sensors 20 attached to the wrist 110 of the hand 100 of the user to measure local forces applied at the wrist 110 as a consequence of moving one or more phalanges 112 of the hand 100 to detect a user input signal 67.

In addition, the at least one memory 92 and the computer program code 94 may be configured to, with the at least one processor 90, cause apparatus 2 at least to perform: assignment of a user input signal 67 to a particular one of multiple user input command channels.

In some examples, the at least one memory 92 and the computer program code 94 are configured, with the at least one processor 90, to cause apparatus 2 at least to perform translation of positional signals 11 provided by the first sensors 10 and control signals 21 provided by the second sensors 20 to standard computer mouse signals.

The computer program 94 may arrive at the circuitry via any suitable delivery mechanism 96, as illustrated in FIG. 10B. The delivery mechanism 96 may be, for example, a non-transitory computer-readable storage medium, a computer program product, a memory device, a record medium such as compact disc read-only memory (CD-ROM) or digital versatile disc (DVD), an article of manufacture that tangibly embodies the computer program 94. The delivery mechanism may be a signal configured to reliably transfer the computer program 94. Circuitry may propagate or transmit the computer program 94 as a computer data signal.

Although the memory 92 is illustrated as a single component it may be implemented as one or more separate components some or all of which may be integrated/removable and/or may provide permanent/semi-permanent/dynamic/cached storage.

Although the processor 90 is illustrated as a single component it may be implemented as one or more separate components some or all of which may be integrated/removable.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi- processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

As used here ‘module’ refers to a unit or apparatus that excludes certain parts/components that would be added by an end manufacturer or a user. The apparatus 2 may be a module.

The blocks illustrated in FIGS. 7 and 8 may represent steps in a method and/or sections of code in the computer program 94. The illustration of a particular order to the blocks does not necessarily imply that there is a required or preferred order for the blocks and the order and arrangement of the block may be varied. Furthermore, it may be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

1-25. (canceled)

26. An apparatus comprising:
a support configured to position the apparatus near wrist of a user;
a first sensor configured to measure movement of the apparatus in space as the apparatus is moved through space; and
one or more second sensor configured to measure at least a force applied to the apparatus as a consequence of movement of a phalange near the wrist.

27. An apparatus as claimed in claim 26, wherein the support is configured to wrap around a carpal portion of the user's wrist.

28. An apparatus as claimed in claim 26, wherein the apparatus is configured to position the one or more second sensors against a posterior portion of the wrist.

29. An apparatus as claimed in claim 26, further comprising a display configured to provide visible information to a user.

30. An apparatus as claimed in claim 26, further configured to additionally operate as a watch and/or mobile cellular telephone and/or controller for an electronic device.

31. An apparatus as claimed in claim 26, wherein the first sensors are configured to provide first output signals configured to control a position of a pointer within a graphical user interface, and wherein the one or more second sensors are configured to provide second output signals configured to control at least user selection within the graphical user interface.

32. An apparatus as claimed in claim 31, wherein the first output signals and the second output signals enable emulation, by the apparatus, of a computer mouse.

33. An apparatus as claimed in claim 31, wherein the first output signals enable positional commands that move a pointer and wherein the second output signals enable one or more of a left button input, a middle button input, a right button input.

34. An apparatus as claimed in claim 26, further comprising circuitry configured to detect a user input signal within second output signals provided by the one or more second sensors.

35. An apparatus as claimed in claim 34 wherein the circuitry is configured to compare a second output signal received from at least one of the one or more second sensors with a reference.

36. An apparatus as claimed in claim 35 wherein the reference comprises a second output signal received previously from the same second sensor and/or wherein the reference comprises a second output signal received contemporaneously from another of the one or more second sensors and/or wherein the reference comprises a second output signal received previously from another of the one or more second sensors.

37. An apparatus as claimed in claim 26, further comprising circuitry configured to assign a second output signal received from a particular one of the one or more second sensors to a particular one of multiple user input command channels.

38. An apparatus as claimed in claim 26, further comprising circuitry configured to perform a calibration procedure configured to enable the assignment of user input command channels to second output signals received from the one or more second sensors.

39. An apparatus as claimed in claim 26, configured to detect whether the apparatus is associated with a left hand or a right hand.

40. An apparatus as claimed in 26 wherein the calibration circuitry is configured to set detection thresholds for detecting second output signals received from second sensors as user input signals.

41. An apparatus as claimed in claim 38, wherein the calibration circuitry is configured to control a display to provide user instructions.

42. A method comprising:
processing signals received from first sensors connected to a wrist of a hand of a user to measure movement of the hand of the user through space; and
processing signals received from one or more second sensors attached to the wrist of the hand of the user to measure local forces applied at the wrist as a consequence of moving one or more phalanges of the hand to detect a user input signal.

43. A method as claimed in claim 42, comprising:
processing the user input signal to emulate a computer mouse signal.
